(19) United States
(12) Patent Application Publication
(10) Pub. No.: US 2005/0021881 A1
(43) Pub. Date: Jan. 27, 2005

(54) Information processing apparatus and information processing method

(75) Inventors: Hisashi Asano, Tokyo (JP); Hiroaki Marutani, Chiba (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 10/861,459

(22) Filed: Jun. 7, 2004

(30) Foreign Application Priority Data
Jun. 11, 2003 (JP) 2003-166643

(51) Int. Cl. G06F 13/10

(52) U.S. Cl. 710/19

(57) ABSTRACT

An audio apparatus for processing arbitrary USB sound data by connecting a USB cable to a personal computer, comprises a USB connector portion for detecting a connected/non-connected status of the USB cable which is connected to the personal computer and a display tube for displaying contents of a communication status based on the connected/non-connected status of the USB cable detected by this USB connector portion. By this configuration, a user can easily and simply confirm a connected/non-connected status of the USB cable, in the audio apparatus having a built-in USB appliance, that is connected to the personal computer from contents of a communication status displayed on the display tube of the audio apparatus.

### BACKGROUND OF THE INFORMATION

1. Field of the Invention

The present invention relates to an information processing apparatus and a method therefor that are well applicable to an audio apparatus having a built-in USB appliance connectable to a personal computer.

2. Description of Related Art

Recently, a USB appliance connectable to a personal computer has been often used in its peripheral such as an audio apparatus, a digital camera, a scanner, a printer, and a TV receiver (visual device). The USB communication standards are provided to the present-day personal computer on a standard basis so that through a USB hub up to 127 peripherals can be connected to one port in a star shape. Further, a USB appliance can be connected to and disconnected from a peripheral in a condition where it is powered.

The peripheral such as a keyboard and a mouse is a relatively low-speed device, coming in either of two types having communication speeds of 1.5 Mbps and 12 Mbps. Presently, in accordance with the USB2.0 standards, a transfer rate has been improved to 360-480 Mbps, to enable high-speed data transfer as well as transfer of music data and image data.

Many of conventional type USB appliances are controlled by a user who operates a personal computer, so that he or she can confirm information such as a connected/non-connected status to the USB appliances on the personal computer. In transfer of music data or image data, an audio or visual device is used as the USB appliance, so that it is possible not only to operate the USB appliance through the personal computer but also to manipulate application software in the personal computer through the USB appliance.

The conventional USB appliance such as an audio apparatus, however, has the following problems.

(1) If such the conventional USB appliance is directly connected to a personal computer to use the connected USB appliance, a user may know information such as a connected/non-connected status of the USB appliance and the personal computer through only the personal computer. On the side of the USB appliance, the user finds it difficult to know the connected/non-connected status to the personal computer correctly when he or she is operating the USB appliance; and

(2) When a USB hub is used to connect a peripheral and a personal computer to each other, either a method for permitting a user to know about a connected/non-connected status through the personal computer or a method for permitting him or her to know about it by turn-ON, turn-OFF, and blinking of an LED on the USB hub is employed. Therefore, even when the user is notified of a trouble in connection status by turn-ON, turn-OFF, or blinking of the LED on the USB hub, he or she repeats a trial-and-error operation with referencing respective manuals of the personal computers, the USB hub, and the USB appliance in order to trace down a cause of the trouble. Therefore, to solve this trouble, it may take much time uselessly.

### SUMMARY OF THE INVENTION

To solve these problems, the present invention has been developed, and it is an object of the present invention to provide an information processing apparatus and an information processing method that permit even an information processing system as a peripheral device on the side of reception to easily and simply confirm a connected/non-connected status of a signal line, which is to be connected to an information processing system having a host control function on the side of transmission.

According to the present invention, the object is achieved by a first information processing apparatus for processing arbitrary information by connecting through a signal line in accordance with predetermined communication standards to an information processing system on the side of transmission. This apparatus comprises a detection device for detecting a connected/non-connected status of the signal line, which is connected to the information processing system on the transmission side. This apparatus also comprises a display device for displaying contents of a communication status based on the connected/non-connected status of the signal line detected by this detection device.

According to the first information processing apparatus related to the present invention, when it processes arbitrary information by connecting the signal line in accordance with the predetermined communication standards to the information processing system on the transmission side, the detection device detects the connected/non-connected status of the signal line, which is to be connected to the information processing system on the transmission side. The display device displays the contents of the communication status based on a detection result detected by the detection means.

Therefore, in an information processing apparatus etc. having a built-in USB appliance, based on the contents of the communication status displayed on the display device, a user easily and simply confirms the connected/non-connected status of the signal line, which is to be connected to the information processing system on the transmission side. Accordingly, the user can correctly know the connected/non-connected status of a USB appliance etc., thereby solving troubles efficiently.

In accordance with another aspect of the invention, a second information processing apparatus processes arbitrary information by connecting an information processing system on the side of transmission and an information processing system on the side of reception to each other through a signal line in accordance with predetermined communication standards. The apparatus comprises a detection device for detecting a connected/non-connected status of the signal line, which is to be connected to the information processing system on the transmission side. The apparatus also comprises a controller for getting control to decide whether communication processing is performed to this information processing system on the transmission side. The apparatus further comprises a display device for displaying contents of a communication status on the information processing system on the reception side based on the connected/non-connected status detected by the detection device and a result of communication to the information processing system on the transmission side decided by the controller.

According to the second information processing apparatus, when it processes arbitrary information by connecting the signal line in accordance with the predetermined communication standards to the information processing system on the transmission side, the detection device detects the connected/non-connected status of the signal line, which is to be connected to the information processing system on the transmission side. According to the controller, it is decided whether communication processing is performed to the information processing system on the transmission side. The display device displays the contents of the communication status in the information processing apparatus on the information processing system on the reception side based on a detection result detected by the detection device and a result of communication to the information processing system on the transmission side decided by the controller.

Therefore, in an information processing apparatus etc. having a built-in USB appliance, based on the contents of the communication status in the information processing apparatus displayed on the display means, a user easily and simply confirms the connected/non-connected status of the signal line, which is to be connected to the information processing system on the transmission side. Furthermore, even if this signal line is physically connected to the information processing system on the transmission side, when communication with the information processing system on the transmission side cannot be performed, it is possible to display that a communication path to the information processing system on the transmission side has not yet been established (fault location section display). Accordingly, the user can correctly know the connected/non-connected status of a USB appliance etc., thereby solving troubles efficiently.

In accordance with further aspect of the invention, a first information processing method involves processing arbitrary information by connecting an information processing system on the side of transmission and an information processing system on the side of reception to each other through a signal line in accordance with predetermined communication standards. The method comprises the steps of detecting a connected/non-connected status of the signal line in the information processing system on the reception side, and displaying contents of a communication status on this reception side based on the detected connected/non-connected status of the signal line.

According to the first information processing method, in the case of processing arbitrary information by connecting an information processing system on the side of transmission and an information processing system on the side of reception to each other through the signal line in accordance with predetermined communication standards, it is possible to easily and simply confirm a connected/non-connected status of the signal line based on the contents of a communication status displayed on the information processing system on the reception side.

In accordance with still further aspect of the invention, a second information processing method involves processing arbitrary information by connecting an information processing system on the side of transmission and an information processing system on the side of reception to each other through a signal line in accordance with predetermined communication standards. The method comprises the steps of detecting a connected/non-connected status of the signal line in the information processing system on the reception side and detecting whether communication processing is performed to the information processing system on the transmission side, and displaying contents of a communication status in the information processing system on the reception side based on the detected connected/non-connected status of the signal line and a detected communication result to the information processing system on the transmission side.

According to the second information processing method, in the case of processing arbitrary information by connecting an information processing system on the side of transmission and an information processing system on the side of reception to each other through a signal line in accordance with predetermined communication standards, it is possible to easily and simply confirm a connected/non-connected status of the signal line based on the contents of the communication status displayed on the information processing system on the reception side. Furthermore, even if this signal line is physically connected to the information processing system, when communication with the information processing system on the transmission side cannot be performed, it is possible to display that a communication path to the information processing system on the transmission side has not yet been established (fault location section display). Accordingly, a user correctly knows a connected/non-connected status of a USB appliance etc., thereby solving troubles efficiently.

The concluding portion of this specification particularly points out and directly claims the subject matter of the present invention. However those skill in the art will best understand both the organization and method of operation of the invention, together with further advantages and objects thereof, by reading the remaining portions of the specification in view of the accompanying drawing(s) wherein like reference characters refer to like elements.

### BRIEF DESCRIPTION OF THE DRAWINGS

FIG. 1 is a system diagram for showing an example of an audio apparatus to which a first embodiment of the present invention is applied;

FIG. 2 is a block diagram for showing an internal configuration of an audio apparatus body;

FIG. 3 is a flowchart for showing a USB-connection display processing example in the audio apparatus;

FIG. 4 is a flowchart for showing another USB-connection display processing example in the audio apparatus according to a second embodiment related to the present invention; and

FIG. 5 is a system diagram for showing an example of the audio apparatus to which a third embodiment of the present invention is applied.

### DESCRIPTION OF THE EMBODIMENTS

The following will describe an information processing apparatus and a method therefor according to embodiments of the present invention with reference to drawings.

(1) First Embodiment

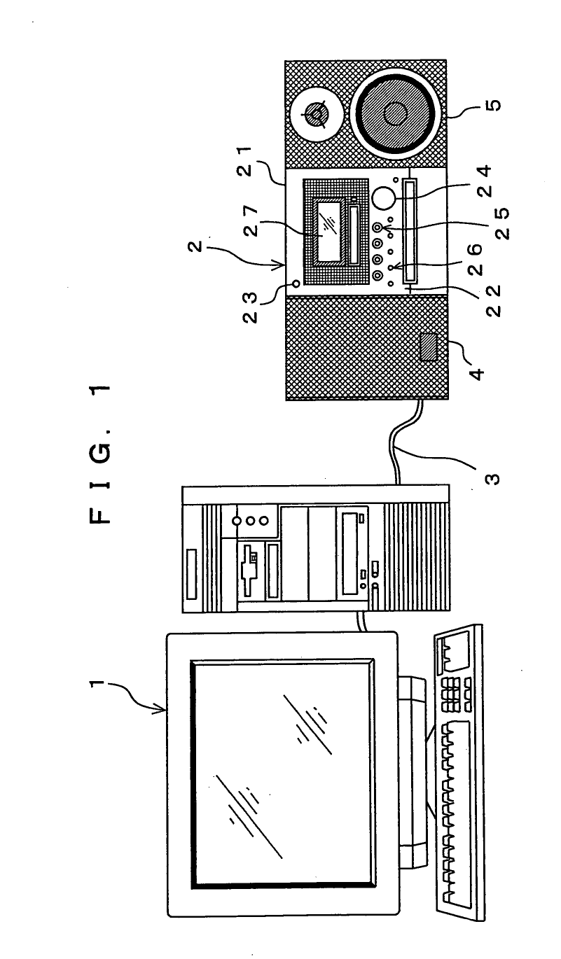

FIG. 1 is a system diagram for showing an example of an audio apparatus 2 to which a first embodiment of the present invention is applied.

In the present embodiment, in a case where audio information etc. are processed by connecting a communication cable in accordance with the USB communication standards to a personal computer having a host control function (which is an information processing system on the side of transmission, and referred as simply “a personal computer” hereinafter), display device is provided for displaying contents of a communication status based on a connected/non-connected status of the USB communication cable which is connected to the personal computer, so that based on the contents of the communication status displayed on this display device, a connected/non-connected status of the communication cable in accordance with the USB communication standards in this audio apparatus can be easily and simply confirmed.

The audio apparatus 2 shown in FIG. 1 is one example of information processing apparatuses. It has a USB (Universal Serial Bus) terminal, not shown, and processes arbitrary audio information in such a configuration that a communication cable in accordance with the USB communication standards (hereinafter referred to as “USB cable 3”), which is one example of signal lines in accordance with predetermined communication standards, is connected to a personal computer 1 directly. USB refers to transfer standards for serial data to be transferred at a low to medium speed. The USB cable 3 is used to connect a variety of peripherals such as a keyboard or a mouse.

This audio apparatus 2 has an audio apparatus body 21 and speakers 4 and 5 for the respective right and left channels, for reproducing contents of a CD, MD, or tape and receiving existing broadcast programs through a tuner. The audio apparatus body 21 has an operation panel 22 on it. The operation panel 22 is equipped with a power switch 23, a volume 24, a function switch 25, a tuning button 26, a display tube 27, etc. The audio apparatus 2 has a function to reproduce a sound or music recorded in a CD, MD, tape, tuner, etc. as well as a built-in USB speaker function. Audio information is taken in from the personal computer 1 through a USB interface, and audio data obtained as a result of processing the information is input to the speakers 4 and 5 for the respective right and left channels and output from the speakers 4 and 5 without being controlled except for sound volume adjustment.

The USB speaker function is incorporated as one function; to use the existing speakers 4 and 5 as a USB speaker, the power switch 23 is turned on (POWER-ON) and the personal computer 1 and the USB cable 3 are connected to each other, then, keys are operated to select a USB speaker-dedicated function and set the USB speaker function. It is thus possible to provide such specifications that upon POWER-ON, the USB speaker function is always operated to sound according to sound information output from the personal computer 1 in the audio apparatus 2.

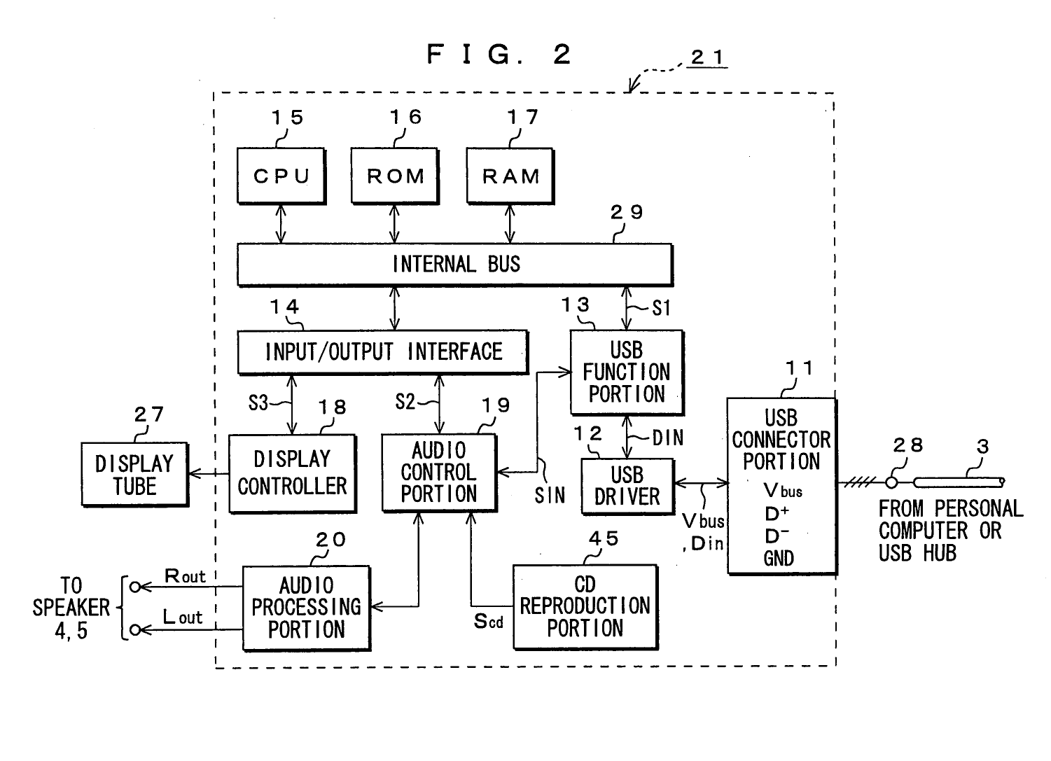

FIG. 2 is a block diagram for showing an internal configuration example of the audio apparatus 2. The audio apparatus 2 has a USB terminal 28. In this embodiment, the personal computer 1 and the audio apparatus 2 are directly connected to each other, so that it can be decided by detecting a Vbus signal applied to the USB terminal 28 whether the USB cable 3 is connected to the USB terminal 28. The Vbus signal is supplied from the personal computer 1 to the audio apparatus 2 and, in the audio apparatus body 21, used to decide a connected/non-connected status. This non-connected status or the like is known by such display as “USB OFF” given on the display tube 27 etc. of the audio apparatus 2.

The audio apparatus 2 shown in FIG. 2 comprises a USB connector portion 11, a USB driver 12, a USB function portion 13, an input/output interface 14, a CPU (Central Processing Unit) 15, an ROM (Read Only Memory) 16, an RAM (Random Access Memory) 17, a display controller 18, an audio control portion 19, an audio processing portion 20, the display tube 27, and an internal bus 29.

The USB connector portion 11 is one example of detection device. To this USB connector portion 11, one end of the USB cable 3 is connected and the other end of it is connected to the personal computer 1. The USB cable 3 is composed of four signal lines. The first signal line transmits the Vbus signal, the second and third signal lines transmit USB signals D+ and D− of audio information etc., and the fourth signal line is connected to a ground potential (GND).

The USB connector portion 11 receives the Vbus signal from the personal computer 1 and detects this Vbus signal, to detect whether the USB cable 3 is connected to the personal computer. Of course, the configuration is not limited to this; for example, the other end of the USB cable 3 may be connected to a USB hub so as to receive and detect the Vbus signal output from the USB hub. Presence of this audio apparatus 2 is automatically confirmed by the operating system in the personal computer 1, followed by automatic incorporation of necessary device drivers. This greatly simplifies incorporation of the audio apparatus 2 in the personal computer 1.

The USB driver 12 performs signal conversion on USB sound information Din received from the personal computer 1 or amplifies the USB sound data DIN obtained after signal conversion. The USB function portion 13 performs USB protocol management based on the USB communication standards. For example, the USB function portion 13 receives a USB control signal Si from the CPU 15 through the internal bus 29 and, based on this USB control signal S, converts it into a USB sound signal SIN and transfers the audio signal SIN obtained after conversion.

The USB function portion 13 is connected to the internal bus 29 and an audio controller 19. Further, to the internal bus 29, the CPU 15, the ROM 16, and the RAM 17 are connected and interconnected with the USB function portion 13. The USB function portion 13 is controlled by the CPU 15 via the internal bus 29. This control enables normal communication between the personal computer and this audio apparatus (USB appliance) to be detected.

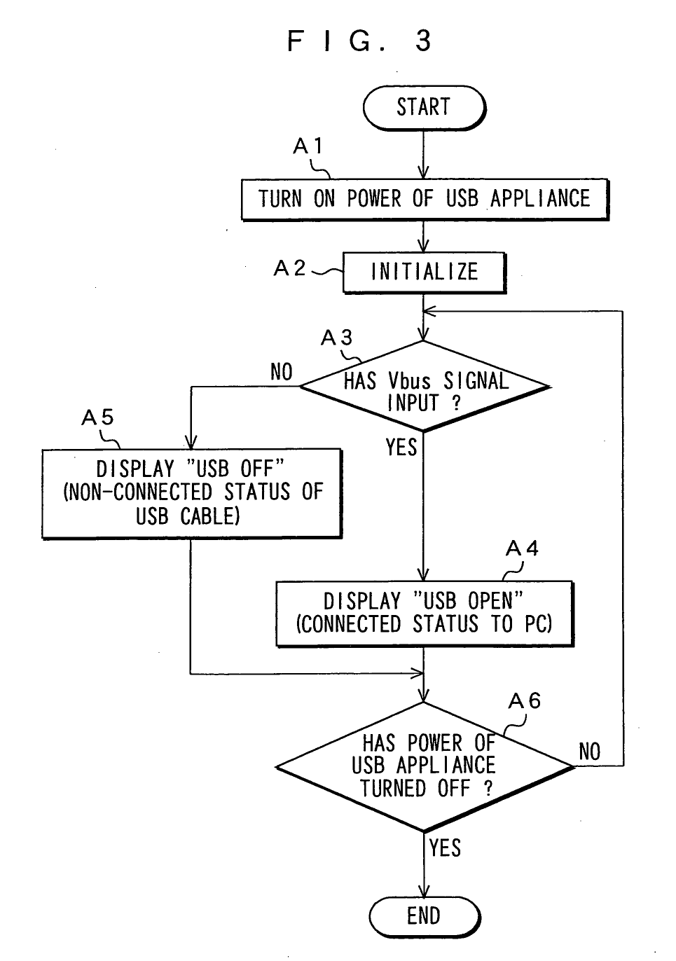

The ROM 16 stores in it a USB-connection display processing program. The USB-connection display processing program is used for detecting a connected/non-connected status of the USB cable 3 in this audio apparatus 2 and displaying contents of a communication status on the display tube 27 of this audio apparatus 2 based on the connected/non-connected status thus detected of the USB cable 3 (see FIG. 3). Of course, the ROM 16 stores in it a system program for controlling the entire audio apparatus. The RAM 17 is used as a working memory when the USB-connection display processing program, the system program or the like is executed or the USB sound data DIN is processed.

The above-mentioned CPU 15, when the power switch 23 is turned on, reads the system program from the ROM 16 to activate this audio apparatus 2 and also reads the USB-connection display processing program to control the USB function portion 13 and also control via the internal bus 29 and the input/output interface 14, the audio control portion 19 and the display controller 18. The internal bus 29 is connected to the input/output interface 14 and interconnected with the CPU 15, the ROM 16, the RAM 17, and the USB function portion 13. To the input/output interface 14, the audio control portion 19 and the display controller 18 are connected.

The audio control portion 19 is connected to the audio processing portion 20. The audio control portion 19 receives an audio control signal S2 from the CPU15 and, based on this audio control signal S2, controls the audio processing portion 20. To the audio processing portion 20, the speakers 4 and 5, not shown, for the respective right and left channels are connected.

For example, the audio processing portion 20 receives from the USB function 13 through the audio control portion 19 the audio signal SIN obtained after information processing is performed on the USB sound information DIN received from the personal computer 1. The audio processing portion 20 also outputs a left-channel audio signal Lout obtained after sound processing is performed on this audio signal SIN to the left-channel speaker 4 and a right-channel audio signal Rout obtained after sound processing is performed similarly to the right-channel speaker 5.

Further, to the audio control portion 19, a compact-disc (hereinafter abbreviated as CD) reproduction portion 45, which, after being mounted with a CD, not shown, reproduces this CD to output a CD-reproduced signal Scd. The CD-reproduced signal Scd is input to the audio processing portion 20 under the control of the audio control portion 19. The audio processing portion 20 performs sound processing on the CD-reproduced signal Scd received from the CD reproduction portion 45. The audio processing portion 20 outputs the left-channel audio signal Lout obtained after this signal processing is performed to the speaker 4 and the right-channel audio signal Rout obtained after sound processing similarly to the speaker 5.

The display controller 18 is connected to the display tube 27, which provides one example of the display device. The display controller 18 receives a display control signal S3 from the CPU15 through the internal bus 29 and the input/output interface 14. Based on this display control signal S3, the display controller 18 provides display control on the display tube 27. As the display tube 27, a flat display element, an LCD, an LED, etc. is used. For example, the display controller 18 controls the display tube 27 so that contents of a communication status may be displayed based on a connected/non-connected status of the USB cable 3 detected by the USB connector portion 11. The display tube 27 displays the contents of the communication status under the display control of the display controller 18. There are the following output examples of the communication status contents to be notified to the user.

(1) Character Display:

The characters such as “USB OFF” that indicates non-connected status of the USB cable 3, and “USB OPEN” that indicates connected status between the USB cable 3 and the personal computer 1 are displayed.

(2) LED Display:

This display is given by turning-ON, turning-OFF, or blinking (whose blinking period and blinking time are changed) LED or combining them. For example, the non-connected status of the USB cable 3 to the personal computer 1 is displayed by turning on the red LED or the connected status of the USB cable 3 to the personal computer 1 is displayed by turning on the green LED. The non-connected status of the USB cable 3 to the personal computer 1 is displayed by turning off the green LED and turning on or blink the red LED in combination of the red and green LEDs. The connected status of the USB cable 3 to the personal computer 1 is displayed by turning off the red LED and the turning on the green LED.

(3) Image Display:

An image is displayed that indicates the non-connected status of the USB cable 3 to the personal computer 1 or the connected status of the USB cable 3 to the personal computer 1. For example, a USB plug indicating the non-connected status of the USB cable 3 is displayed as an icon.

Alternatively, in stead of the display using the display tube 27, the non-connected status or the connected status of the USB cable 3 to the personal computer 1 may be indicated by sound message.

The following will describe a first information processing method related to the present invention. FIG. 3 is a flowchart for showing a USB-connection display processing example in the audio apparatus 2.

In the present embodiment, as the signal line in accordance with the predetermined communication standards the USB cable 3 is used, and as the information processing apparatus the audio apparatus (information processing system as a peripheral device on reception side) 2 having the built-in USB speaker functions is used. Further, on the assumption that arbitrary USB sound data DIN is processed by connecting the personal computer 1 and the audio apparatus 2 to each other through the USB cable 3, the connected/non-connected status of the USB cable 3 is detected at the audio apparatus 2, so that based on the detected connected/non-connected status of the USB cable 3, contents of the communication status are displayed on the display tube 27 of this audio apparatus 2.

Under these processing conditions, at step A1 of the flowchart shown in FIG. 3, a user operates the power switch 23 on the audio apparatus 2 to turn on its power. Then, the process goes to step A2 where the CPU15 initializes the USB function portion 13 etc. Then, at step A3, the USB connector portion 11 detects whether the Vbus signal has input from the personal computer 1.

If the Vbus signal has input to the USB connector portion 11, the process goes to step A4 where “USB OPEN” indicating the connected status of this audio apparatus 2 with the personal computer 1 is displayed on the display tube 27. The user can visually observe this display of “USB OPEN” to thereby confirm that the personal computer 1 and this audio apparatus 2 are connected to each other. The audio controller 18 gets control so that arbitrary USB sound data DIN can be input from the user's personal computer 1 to this audio apparatus 2, which performs reproduction processing and the like. Then, the process goes to step A6.

It is to be noted that if the Vbus signal has not yet been input to the USB connector portion 11 at step A3, that is, if the USB connector portion 11 fails to detect the Vbus signal from the personal computer 1, the process goes to step A5. At step A5, “USB OFF” indicating non-connected status between the personal computer 1 and this audio apparatus 2 is displayed on the display tube 27. The user can visually observe this display of “USB OFF” to thereby confirm that the personal computer 1 and this audio apparatus 2 have not yet been connected to each other.

Thereafter, the process goes to step A6 where it is detected whether the power of the USB appliance has been in an OFF state. If the power switch 23 of the USB appliance is turned OFF, the process ends USB-connection display processing. Otherwise, the process returns to step A3 to repeat the above-mentioned USB-connection display processing.

As described above, according to an audio apparatus and an information processing method to which an information processing apparatus according to the first embodiment of the present invention is applied, when arbitrary USB sound data DIN is processed by connecting the USB cable 3 to the personal computer 1, the connected/non-connected status of the USB cable 3, which is to be connected to the personal computer 1, is detected by the USB connector portion 11. On the display tube 27, contents of a communication status are displayed based on the connected/non-connected status of the USB cable 3 detected by the USB connector portion 11.

Therefore, in the audio apparatus 2 having the built-in USB speaker functions, from the contents of the communication status displayed on the display tube 27 or the like, the user can easily and simply know the connected/non-connected status of the USB cable 3. Accordingly, the user can correctly know the connected/non-connected status of the USB appliance etc., thereby solving troubles efficiently.

(2) Second Embodiment

An audio apparatus 2 according to the present embodiment processes arbitrary USB sound data DIN by connecting a personal computer 1 and the audio apparatus 2 to each other through a USB cable 3 as shown in FIG. 2. The present embodiment is different from the first embodiment in that a CPU15 decides whether communication processing is performed to the personal computer 1 connected to a USB connector portion 11 through the USB cable 3 shown in FIG. 2 and that it is equipped with a display tube 27 which displays contents of a communication status on the audio apparatus 2 based on a connected/non-connected status of the USB cable 3 detected by the USB connector portion 11 and a result of communication to the personal computer 1 detected by the CPU15 (second information processing apparatus).

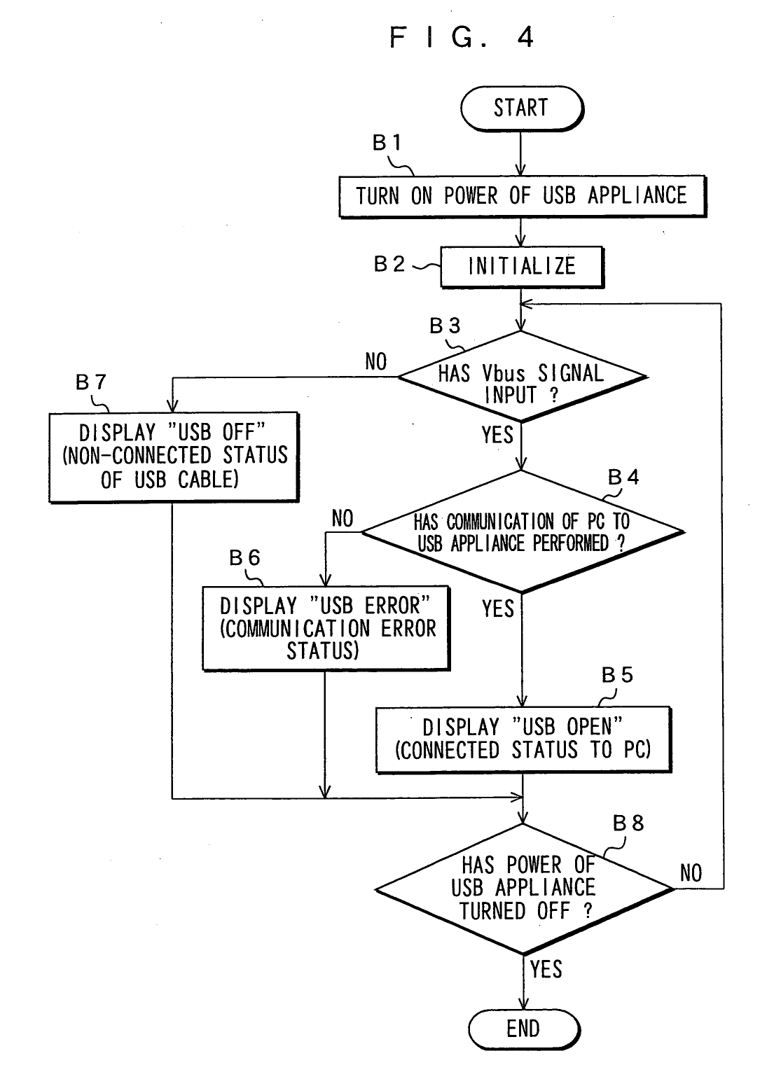

FIG. 4 is a flowchart for showing another USB-connection display processing example in the audio apparatus 2 according to the second embodiment related to the present invention. In the present embodiment, as in the case of the first embodiment, the USB cable 3 is used, and as the information processing apparatus the audio apparatus 2 having built-in USB speaker functions is used.

Further, such an example is given that on the assumption that arbitrary USB sound data DIN is processed by connecting the personal computer 1 and the audio apparatus 2 to each other through the USB cable 3, the connected/non-connected status of the USB cable 3 is detected at the audio apparatus 2 and whether communication processing can be performed to the personal computer 1 is detected, so that based on the detected connected/non-connected status of the USB cable 3 and a detected result of the communication on the personal computer 1, contents of the communication status are displayed as an image on the display tube 27 of the audio apparatus 2 (second information processing method).

Under these processing conditions, at step B1 of the flowchart shown in FIG. 4, a user operates a power switch 23 on the audio apparatus 2 to turn on its power. Then, the process goes to step B2 where the CPU15 initializes a USB function portion 13 etc. Then, at step B3, the USB connector portion 11 detects whether the Vbus signal has input from the personal computer 1.

If the Vbus signal has input to the USB connector portion 11, the process goes to step B4 where the CPU15 decides whether communication of the personal computer 1 (PC) to the USB appliance (this audio apparatus 2) has performed. This decision is made by utilizing processing of the operating system (OS) of the personal computer 1 to recognize the USB appliance such as this audio apparatus 2. For example, when the USB appliance is connected through the USB cable 3, in order to permit use of the USB appliance on the OS, the OS of the personal computer 1 communicates with this audio apparatus 2 so as to transfer information concerning which type of the USB appliance it is. The CPU15 of the audio apparatus 2 decides that it is connected to the personal computer 1 by detecting communication processing of this information.

Therefore, if it is decided that communication processing is performed from the personal computer 1 to this audio apparatus 2, the process goes to step B5 where “USB OPEN” indicating the connected status of this audio apparatus to the personal computer 1 is displayed on the display tube 27. The user can visually observe this display of “USB OPEN” to thereby confirm that the personal computer 1 and this audio apparatus 2 are connected to each other. An audio controller 18 gets control so that arbitrary USB sound data DIN can be input from the user's personal computer 1 to this audio apparatus 2, which performs reproduction processing etc. Then, the process goes to step B8.

If it is decided that communication processing has not performed from the personal computer 1 to this audio apparatus 2, the process goes to step B6 where “USB ERROR” indicating an error in communication from the personal computer 1 to this audio apparatus 2 is displayed on the display tube 27. The user can visually observe this display of “USB ERROR” to thereby confirm that the personal computer 1 does not communicate to this audio apparatus 2. Then, the process goes to step B8.

It is to be noted that if the Vbus signal has not input to the USB connector portion 11 at step B3, that is, if the USB connector portion 11 fails to detect the Vbus signal from the personal computer 1, the process goes to step B7. At step B7, “USB OFF” indicating that the personal computer 1 and this audio apparatus 2 have not yet connected to each other is displayed on the display tube 27. The user can visually observe this display of “USB OFF” to thereby confirm that the personal computer 1 and this audio apparatus 2 have not yet been connected to each other.

Thereafter, the process goes to step B8 where it is detected whether the power of the USB appliance is in an OFF state. If the power switch 23 of the USB appliance is turned OFF, the process ends USB-connection display processing. Otherwise, the process returns to step B3 to repeat the above-mentioned USB-connection display processing.

As described above, according to an audio apparatus 2 and an information processing method to which an information processing apparatus according to the second embodiment of the present invention is applied, when arbitrary USB sound data DIN is processed by connecting the USB cable 3 to the personal computer 1, the connected/non-connected status of the USB cable 3, which is to be connected to the personal computer 1, is detected by the USB connector portion 11. The CPU15 decides whether communication processing is performed to the personal computer 1. On the display tube 27, contents of a communication status are displayed based on the connected/non-connected status of the USB cable 3 detected by the USB connector portion 11 and a result of communication to the personal computer 1 decided by the CPU15.

Therefore, in the audio apparatus 2 having the built-in USB speaker functions, from the contents of the communication status displayed as an image on the display tube 27, the user can easily and simply know the connected/non-connected status of the USB cable 3, which is to be connected to the personal computer 1. Furthermore, even in a case where this USB cable 3 is physically connected to the personal computer 1, if communication to the personal computer 1 cannot be performed, it is possible to give display to the effect that a communication path to the personal computer 1 has not yet been established (fault location section display). Accordingly, the user can correctly know the connected/non-connected status of a USB appliance such as this audio apparatus 2, thereby solving troubles efficiently.

(3) Third Embodiment

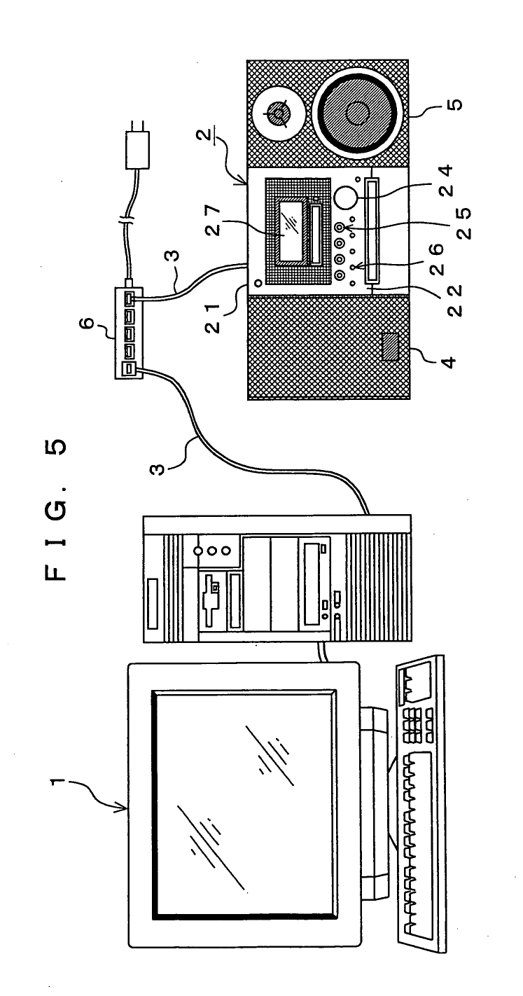

FIG. 5 is a system diagram for showing an example of the audio apparatus 2 to which the third embodiment of the present invention is applied.

In the present embodiment, an audio apparatus 2 equipped with a USB terminal and a personal computer 1 are connected to each other via a self-power USB hub 6 through a USB cable 3. When the self-power USB hub 6 is used, a Vbus signal is supplied from the USB hub 6 to the audio apparatus 2. When a bus-power USB hub is used, the Vbus signal is also supplied from the USB hub 6 etc. to the audio apparatus 2. When these USB hubs 6 are used, it is possible to decide from the Vbus signal that the USB cable 3 has not connected between the personal computer 1 and the USB hub 6 and between the USB appliance and the USB hub 6, thereby displaying “USB OFF” on a display tube 27.

In this embodiment also, as in the cases of the first and second embodiments, a connected/non-connected status between the audio apparatus 2 and the USB hub 6 is decided by detecting the Vbus signal. That is, in a condition where the audio apparatus 2 and the USB hub 6 are connected to each other, “Vbus signal being present” is detected by a USB connector portion 11. However, a connected/non-connected status between the personal computer 1 and the USB hub 6 cannot be detected by the flowchart shown in FIG. 3. Therefore, according to the flowchart shown in FIG. 4, the Vbus signal is detected and also whether communication with the personal computer 1 is possible is decided by a CPUl5 (Refer to step B4 and B5 of FIG. 4).

If, in this case, it is decided that the personal computer 1 has not communicated to this audio apparatus 2, “USB ERROR” indicating an error state in communication from the personal computer 1 to this audio apparatus 2 is displayed on the display tube 27. The user can visually observe this display of “USB ERROR” to thereby confirm that the personal computer 1 has not communicated to this audio apparatus 2.

In such a manner, according to the audio apparatus 2 equipped with a USB terminal of the third embodiment related to the present invention, when this audio apparatus 2 and the personal computer 1 are connected via the self-power USB hub 6 through the USB cable 3, a connected/non-connected status of the USB cable 3, which is to be connected to the personal computer 1, is detected by the USB connector portion 11. The CPUl5 decides whether communication processing is performed to the personal computer 1. On the display tube 27, contents of a communication status are displayed based on the connected/non-connected status of the USB cable 3 detected by the USB connector portion 11 and a result of communication to the personal computer 1 detected by the CPU15.

Therefore, even in a case where it is connected to the personal computer 1 via the self-power USB hub 6 by the USB cable 3, in the audio apparatus 2 having the built-in USB speaker functions, from the contents of the communication status displayed on the display tube 27, the user can easily and simply know the connected/non-connected status of the USB cable 3, which is to be connected to the personal computer 1. Furthermore, even in a case where this USB cable 3 is physically connected to the personal computer 1, if communication to the personal computer 1 cannot be performed, it is possible to give display to the effect that a communication path to the personal computer 1 has not yet established (fault location section display).

Accordingly, the user can correctly know the connected/non-connected status of a USB appliance such as this audio apparatus 2, thereby solving troubles efficiently. Further, as for display means, the display tube 27 equipped to the USB appliance can be utilized to thereby realize display of “USB OFF” without new costs.

Thus has been described an audio apparatus having a built-in USB appliance connectable to a personal computer as an information processing apparatus to which the present invention is well applied. The present invention is not limited this, it also applies to another information processing apparatus including a USB appliance connectable to a personal computer such as a digital camera, a scanner, a printer, and a TV receiver.

While the foregoing specification has described preferred embodiment(s) of the present invention, one skilled in the art may make many modifications to the preferred embodiment without departing from the invention in its broader aspects. The appended claims therefore are intended to cover all such modifications as fall within the true scope and spirit of the invention.

1. An information processing apparatus for processing information by connecting through a signal line in accordance with predetermined communication standards to an information processing system on the side of transmission, comprising:
a detection device for detecting a connection condition of the signal line connected to the information processing system on the transmission side;
a display device for displaying contents of a communication status based on a detection result detected by this detection device.

2. The information processing apparatus according to claim 1, wherein the signal line in accordance with the predetermined communication standards is a communication cable in accordance with USB standards.

3. An information processing apparatus for processing information by connecting an information processing system on the side of transmission and an information processing system on the side of reception to each other through a signal line in accordance with predetermined communication standards, comprising:
a detection device for detecting a connection condition of the signal line connected to the information processing system on the transmission side;
a controller for getting control to decide whether communication processing is performed to this information processing system on the transmission side;
a display device for displaying contents of a communication status on the information processing system on the reception side based on a detection result detected by the detection device and a result of communication to the information processing system on the transmission side decided by the controller.

4. The information processing apparatus according to claim 3, wherein the signal line in accordance with the predetermined communication standards is a communication cable in accordance with USB standards.

5. An information processing method for processing information by connecting an information processing system on the side of transmission and an information processing system on the side of reception to each other through a signal line in accordance with predetermined communication standards, comprising the steps of:
detecting a connection condition of the signal line in the information processing system on the reception side; and
displaying contents of a communication status on the information processing system on the reception side based on a detected connection result of the signal line.

6. The information processing method according to claim 5, wherein as the signal line in accordance with the predetermined communication standards a communication cable in accordance with USB standards is used, and as the information processing system on the reception side an audio apparatus having a built-in USB appliance is used.

7. An information processing method for processing information by connecting an information processing system on the side of transmission and an information processing system on the side of reception to each other through a signal line in accordance with predetermined communication standards, comprising the steps of:
detecting a connection condition of the signal line in the information processing system on the reception side and also detecting whether communication processing is performed to the information processing system on the transmission side; and
displaying contents of a communication status on the information processing system on the reception side based on a detected connection result of the signal line and a detected communication result to the information processing system on the transmission side in the detecting step.

8. The information processing method according to claim 7, wherein as the signal line in accordance with the predetermined communication standards a communication cable in accordance with USB standards is used, and as the information processing system on the reception side an audio apparatus having a built-in USB appliance is used.
